(19) United States
(12) Patent Application Publication
(10) Pub. No.: US 2024/0159900 A1
(43) Pub. Date: May 16, 2024

(54) ENHANCED FISH DETECTION SYSTEM

(71) Applicant: Michael L. Roller, Purdy, MO (US)

(72) Inventor: Michael L. Roller, Purdy, MO (US)

(21) Appl. No.: 18/510,326

(22) Filed: Nov. 15, 2023

Related U.S. Application Data
(60) Provisional application No. 63/425,497, filed on Nov. 15, 2022.

(51) Int. Cl. G01S 15/96; G01S 15/89

(52) U.S. Cl. CPC G01S 15/96; G01S 15/894; G01S 15/8945

(57) ABSTRACT

A fish detection system including a transducer configured to provide image information for underwater locations, a directional member, and a light assembly. The directional member is member configured to move in conjunction with the transducer, the orientation of the directional member corresponding to a direction of the adjustable field of view of the transducer. The light assembly is configured to illuminate the directional member.

### CROSS-REFERENCE TO RELATED APPLICATION

This application claims priority to and the benefit of U.S. Provisional Patent Application Ser. No. 63/425,497, entitled “ENHANCED FISH DETECTION SYSTEM,” filed Nov. 15, 2022, the contents of which are incorporated herein in their entirety.

### TECHNICAL FIELD

This disclosure relates generally to a fish detection system and, more particularly, to a fish detection system including a transducer assembly that is operated independently of a trolling motor.

### BACKGROUND

Fish detection systems assist with detecting fish in lakes and other bodies of water and provide underwater information such as water depth, distribution of fish, and the condition of the body of water. Many fish detection systems comprise sound navigation and ranging (SONAR) transducers and a corresponding display device. In these systems, the transducer emits signal waves into the water, and portions of the waves reflect off of objects and travel back to the transducer. The reflected waves are recorded to determine the location of the fish, which is then displayed on the display device of the system.

A trolling motor is a self-contained unit that includes a motor, propeller, and controls. Trolling motors may be affixed to the boat via a shaft. Trolling motors are often the secondary means of propulsion for a boat and enable a person to fish methodically and quietly. For example, trolling motors enable a boat to stay in one spot when fighting against current or wind without deploying a physical anchor. A trolling motor may be powered by battery, gasoline, or other fuel, and it may be controlled via foot or hand control switches connected to the motor.

In some embodiments, the transducer assembly may be fixedly attached to and operated with the trolling motor. As a result, operation of the transducer assembly may be limited or impeded by the trolling motor. For example, the location of the fish may be in a direction that is different than the direction of the trolling motor, and/or the area measured by the transducer assembly may not be visible to the person operating the trolling motor. Further, the trolling motor may sometimes interfere with the transducer, thereby reducing the effectiveness of the fish detection system.

Accordingly, there is a need for a fish detection system including a transducer assembly that may be operated independently of the trolling motor and that provides enhanced features in comparison to previous fish detection systems.

### BRIEF DESCRIPTION

In one aspect, a fish detection system is provided. The fish detection system includes a transducer configured to provide image information for underwater locations, a directional member, and a light assembly. The directional member is member configured to move in conjunction with the transducer, the orientation of the directional member corresponding to a direction of the adjustable field of view of the transducer. The light assembly is configured to illuminate the directional member.

In another aspect, a fish detection system is provided. The fish detection system includes a mount that attaches to a boat that floats on water, a shaft attached to the mount and configured to extend into the water, and a transducer configured to provide image information for underwater locations. The fish detection system also includes a rechargeable battery connected to the transducer and configured to supply power to the transducer during operation of the transducer. The fish detection system further includes a solar panel for recharging the battery.

In yet another aspect, a fish detection system is provided. The fish detection system includes a transducer configured to provide image information for underwater locations, a motor configured to rotate the transducer to provide an adjustable field of view, and a wireless remote control device communicatively coupled to the motor and configured to receive user input. The wireless remote control device is configured to selectively actuate the motor and change the adjustable field of view of the transducer.

### BRIEF DESCRIPTION OF THE DRAWINGS

FIG. 1 is a perspective of one suitable embodiment of a fish detection system for use on a boat, the fish detection system including a transducer assembly, an imaging module, and a display device.

FIG. 2 is a block diagram of the fish detection system shown in FIG. 1.

FIG. 3 is a side view of one suitable embodiment of the transducer assembly of the fish detection system shown in FIG. 1.

FIG. 4 is a top view of a portion of the transducer assembly shown in FIG. 3, illustrating a gear assembly of the transducer assembly.

FIG. 5 is a side view of another suitable embodiment of the transducer assembly of the fish detection system shown in FIG. 1, the transducer assembly including a light assembly.

FIG. 6 is a front view of a portion of the transducer assembly shown in FIG. 5, illustrating a housing and the light assembly.

FIG. 7 is a side view of yet another suitable embodiment of the transducer assembly of the fish detection system shown in FIG. 1, the transducer assembly including a motor assembly mounted on a shaft of the transducer assembly.

FIG. 8 is a perspective view of a directional member 201 for use with the transducer assembly 200.

The following detailed description is to be read with reference to the figures, in which like elements in different figures have like reference numerals. The figures, which are not necessarily to scale, depict selected embodiments and are not intended to limit the scope of the present disclosure. Skilled artisans will recognize the examples provided herein have many useful alternatives and fall within the scope of the present disclosure.

### DETAILED DESCRIPTION

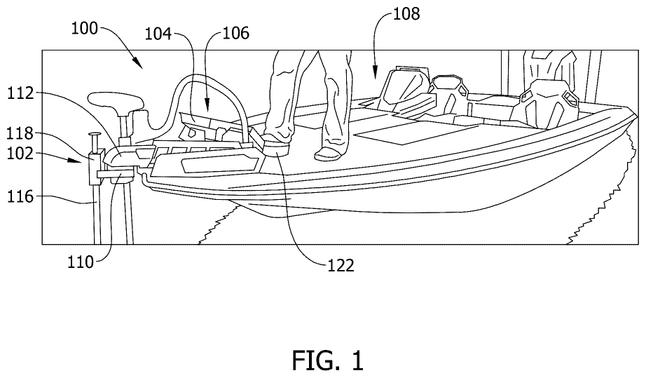

FIG. 1 illustrates one suitable embodiment of a fish detection system 100. The fish detection system 100 includes a transducer assembly 102, an imaging module 104, and a display device 106. The transducer assembly 102, the imaging module 104, and/or the display device 106 may suitably be mounted to or otherwise be integrated into a marine vessel (e.g., a boat 108). The transducer assembly 102 may include a stock off-the-shelf sonar system, or a custom sonar system. Non-limiting examples of a commercially available sonar system for use in the transducer assembly 102 include the STRIKER™ fish finders available from GARMIN®.

As seen in FIG. 1, the transducer assembly 102 is attached to the boat 108 by a transducer assembly mount 110. More specifically, the transducer assembly mount 110 illustrated in FIG. 1 is attached to a trolling motor 112, which is attached to the boat 108. In some embodiments, the transducer assembly mount 110 may comprise a first bracket and a second bracket, each with a plurality of holes for receiving screws to attach the transducer assembly mount 110 to the trolling motor 112. In other suitable embodiments, the transducer assembly mount 110 may be attached to the trolling motor 112. In addition, the transducer assembly mount 110 supports a shaft 116 of the transducer assembly 102 such that the shaft 116 extends into the water in a use position.

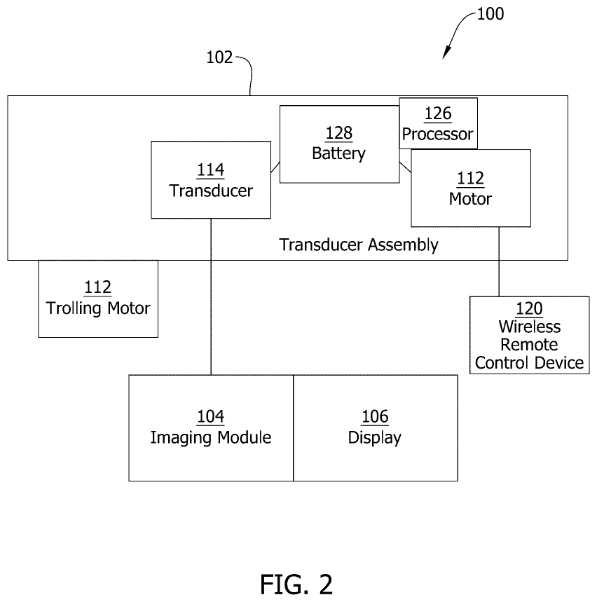

FIG. 2 is a block diagram of the fish detection system 100. The fish detection system 100 includes the transducer assembly 102, the imaging module 104, and the display device 106. The fish detection system 100 includes an internal power source (e.g., a battery 128) connected to the transducer assembly 102, the imaging module 104, and/or the display device 106 that is configured to supply power for components of the fish detection system 100. However, in some suitable embodiments, any components of the fish detection system 100 may receive power from an external power source such as a power source on board the vessel (e.g., the boat 108).

The transducer assembly 102, the imaging module 104, and/or the display device 106 may communicate via wired or wireless communication. For example, the transducer 114 of the transducer assembly 102 may receive the reflected sonar signals at a first location and wirelessly communicate the received signals to the imaging module 104 and/or the display device 106 at a second location mounted on the boat 108 using Bluetooth®, Wi-Fi, or any other wireless communication technique known in the art. In some embodiments, the imaging module 104 and/or the display device 106 may be incorporated into a personal computing device such as a smartphone or a tablet.

Referring to FIGS. 1 and 2, the transducer 114 is configured to provide image information for underwater locations by transmitting and receiving signals. In particular, the transducer 114 transmits sonar signals (also referred to herein as a sonar beam) into a body of water. Objects in the body of water (e.g., fish) obstruct the path of the sonar signals transmitted by the transducer 114 and produce reflected signals or echoes in response, which are received by the transducer 114. Although the transducer assembly 102 is shown including one transducer 114, any numbers of transducers may be included in the transducer assembly 102.

The transducer 114 is attached to the shaft 116 of the trolling motor assembly 102. For example, the transducer 114 is mounted to the shaft 116 such that the transducer is positioned underwater in a use position. In addition, the transducer assembly 102 is configured to switch between the use position and a stow position. For example, the transducer assembly 102 is attached to the trolling motor 112 and pivots relative to the boat 108 with the trolling motor 112 between the use position and the stow position. In some embodiments, the depth of the transducer 114 in the water may be adjusted by lowering or raising the shaft 116 and/or the transducer 114 relative to the boat 108. In other embodiments, the depth of the transducer 114 in the water may be adjusted by selecting a length of the shaft 116 based on a desired depth for the transducer 114 in the water. In addition, the transducer assembly mount 110 enables the transducer 114 to move independently of the trolling motor 112 (e.g., the transducer 114 rotates about a longitudinal axis of shaft 116 and/or relative to the trolling motor 112) to provide an adjustable field of view. Therefore, a user may be able to independently control the boat 108 via the trolling motor 112 and look for fish via the transducer 114.

The imaging module 104 is in communication with the transducer 114 to process the sonar signals received by the transducer 114 and generate sonar images based on the processed sonar signals. The sonar images are displayed on the display device 106. For example, the display device 106 is communicatively coupled with the imaging module 104 and/or the transducer assembly 102 to display the determined locations of fish on a user interface. The determined locations of fish may be indicated on a map displayed on the user interface. In some embodiments, the location of fish may be indicated using one or more colors and/or symbols on the map displayed on the user interface. In some embodiments, the display device 106 may be a digital screen. The sonar images displayed on the display device 106 are associated with the underwater environment, specifically depicting the location of the underwater objects that obstruct the sonar signals and produce the reflected signals received by the transducer 114.

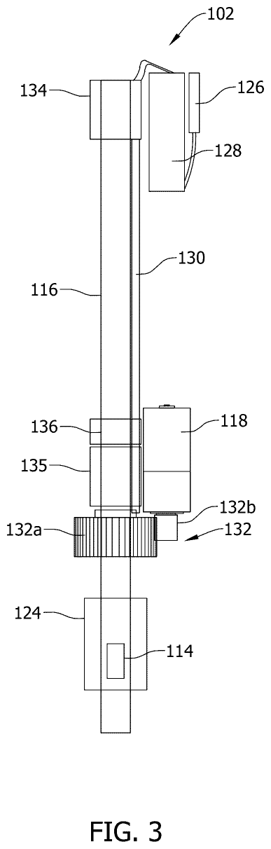

The transducer assembly 102 may further comprise a motor 118 coupled to the shaft 116 and/or the transducer 114 that is configured to rotate the shaft 116 and/or the transducer 114. For example, the motor 118 may be connected to the shaft 116 via a connector such as a shielded slip ring 136 (such as shown in FIG. 3). In some embodiments, the motor 118 may comprise a 12-volt operative reversible motor. The motor 118 is controlled by a wireless remote control device 120 such as a foot control switch (e.g., a pedal) and/or a handheld remote. The foot control switch may be located next to foot pedals 122, which control the trolling motor 112. In some suitable embodiments, the foot control switch may comprise two controls: one for rotating the transducer clockwise and the other for rotating the transducer counter-clockwise. In further suitable embodiments, the handheld remote may be incorporated into a personal computing device such as a tablet or a smartphone, or the handheld remote may be a stand-alone device including one or more inputs and a transceiver to send wireless signals.

The wireless remote control device 120 is communicatively coupled to the motor and configured to receive user input. For example, the wireless remote control device 120 is configured to send instructions to selectively actuate the motor and change the field of view of the transducer 114 based on inputs received from the user. The motor 118 may be communicatively coupled to the wireless remote control device wirelessly via Bluetooth, near-field communication, Wi-Fi, or any other wireless communication methods known in the art. In some embodiments, the motor 118 may be enclosed in a housing. In the example embodiment, the motor 118 is an electric motor and is configured to receive power from the battery 128.

In operation, to identify the location of fish in the water, the transducer 114 transmits sonar signals into the water. Fish and other objects obstruct the path of the sonar signals and produce reflections or echoes that are received by the transducer 114 and processed by the imaging module 104, and sonar images thereof are displayed on the display device 106. To change the field of view of the transducer assembly 102 and receive images of further underwater locations, the user may reposition the transducer assembly 102 using the wireless remote control device 120 independently of controlling the trolling motor 112. Suitably, the user may rotate the transducer assembly 102 up to 360° and identify fish anywhere in the vicinity of the boat 108.

FIG. 3 illustrates one suitable embodiment of the transducer assembly 102. The transducer assembly 102 includes the shaft 116, a transducer mount 124 coupled to the shaft 116, and the transducer 114. The transducer 114 is attached to the transducer mount 124, which is supported on the shaft by one or more gears 132. The transducer assembly 102 further comprises a processor 126 and the battery 128. The processor 126 is mounted to the battery 128, and the battery 128 is attached to the shaft 116 via a connector such as a shielded slip ring 134.

The battery 128 is configured to provide power for one or more components of the transducer assembly 102 during operation. For example, the battery 128 may be attached to and configured to provide power to the motor 118 and/or the transducer 114. In the illustrated embodiment, a cable 130 (such as, but not limited to, a shielded umbilical) extends along the shaft 116 between the motor 118 and the battery 128 to connect the battery 128 to the motor 118 and the transducer 114. Suitably, the battery 128 is a rechargeable battery. For example, the rechargeable battery may be connected to an external power source for recharging via a cable and/or the rechargeable battery may be connected to a charging station. In some embodiments, the battery 128 may be removably attached to a housing such that the battery 128 can be removed for recharging and/or replacement.

In one suitable embodiment, the transducer assembly 102 includes one or more solar panels 129 for recharging the battery 128. Suitably, the solar panels are attached to or form at least a part of the housing of the transducer assembly 102. In other suitable embodiments, the solar panels are separate from the housing and can be placed at various locations on the boat 108. In such an embodiment, a suitable cable can be used to connect the solar panels to the rechargeable battery.

In addition, the battery 128 may be modular and may be replaced with an off-the-shelf battery. The battery 128 enables the transducer assembly 102 to be self-powered such that the transducer assembly 102 does not rely on power from the boat 108 or systems on the boat 108. In addition, the battery 128 simplifies installation of the fish detection system 100 and facilitates compatibility of the fish detection system 100 with a greater number of boats and/or trolling systems because the fish detection system 100 does not necessarily require external power sources or specialized power connections.

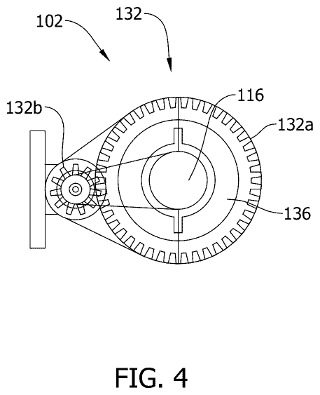

FIG. 4 illustrates the one or more gears 132 of the transducer assembly 102. The one or more gears 132 are coupled to the shaft 116. In some embodiments, the gears 132 may be connected to the shaft 116 by a connector such as a shielded slip ring 136. The one or more gears 132 comprise a first gear 132a encompassing and concentric with the shaft 116 and a second gear 132b mounted on the motor 118. The motor 118 is configured to turn the second gear 132b, which in turn travels about the circumference of the first gear 132a and the shaft 116. Accordingly, the motor 118 is configured to rotate, via the second gear 132b, the transducer mount around the shaft 116 and thereby rotate the transducer and enable the system to detect fish in various directions. In some suitable embodiments, the motor 118 may rotate the shaft 116. In some embodiments, the transducer may be configured to rotate 360°. In addition, the transducer assembly 102 includes a radial position digitizer 135, which detects a position of the shaft 116, the motor 118, and/or the transducer 114 and provides position information to, for example, the wireless remote control device 120 (shown in FIG. 2).

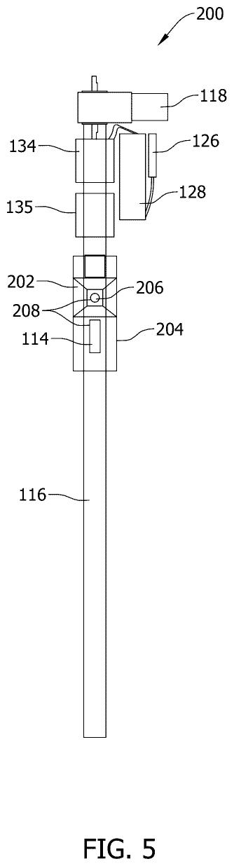

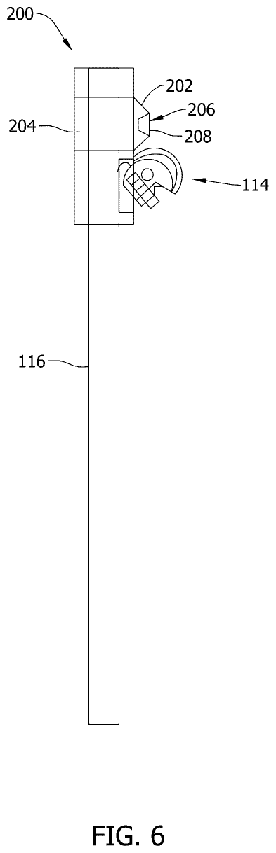

Referring to FIGS. 5 and 6, another suitable embodiment of a transducer assembly 200 for use with the fish detection system 100 (shown in FIG. 1) includes a light assembly 202 attached to at least one of the shaft 116 and the transducer 114. In the example, the light assembly 202 is attached to a housing 204 on the shaft 116 at a location above the transducer 114. The light assembly 202 includes a light source 206 (e.g., a light emitting diode, an incandescent bulb, a laser, a fluorescent light source, an infrared light source, and/or any other suitable light source) and is configured to illuminate an area and allow a user to see where they are fishing. Suitably, the light assembly 202 is configured to move in conjunction with the transducer 114 and illuminate an area that corresponds with the field of view of the transducer 114. For example, the housing 204 supporting the light assembly 202 is directly connected to the transducer 114 and is configured to rotate with the transducer 114 when the motor 118 induces rotation of the transducer 114. In some embodiments, the light assembly 202 and/or the housing 204 is attached directly to the motor 118, or to a separate motor, and to be directly rotated by the motor. In the illustrated embodiment, the housing 204 encloses and supports the light assembly 202 and the transducer 114. The housing 204 includes openings or windows 208 that enable the light source 206 to transmit light and/or the transducer 114 to transmit and receive signals therethrough.

In operation, the user may reposition the transducer assembly 200 using the wireless remote control device 120 (shown in FIGS. 1 and 2). The light assembly 202 rotates with the transducer assembly 102 to illuminate an area corresponding with the field of view of the transducer assembly 102. Thereby, the user can visually see the location that the transducer assembly 102 is aimed at, and the user is able to see a target location, enabling the user to position fishing equipment to be closer in proximity to the fish located on the display device 106.

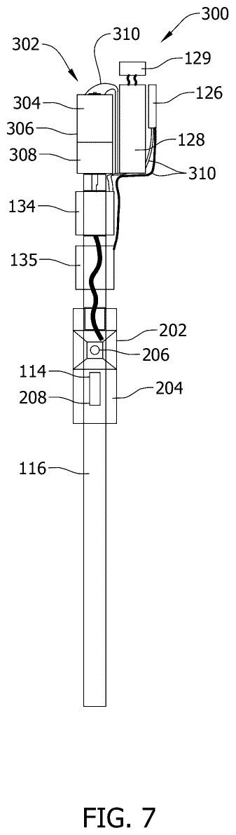

FIG. 7 is a side view of another suitable embodiment of a transducer assembly 300 for use with the system of FIG. 1. The transducer assembly 300 is similar to the transducer assembly 102 shown in FIG. 3, except that the transducer assembly 300 includes a motor assembly 302 mounted on an end of the shaft 116 of the transducer assembly 300. The motor assembly 302 includes a motor 304, a motor housing 306, and a gear assembly 308. The motor housing 306 encloses the motor 304 and the gear assembly 308 and extends around the end of the shaft 116. The gear assembly 308 includes gears (not shown) that engage a drive output of the motor 304 and induce rotation of the shaft 116 during operation of the motor 304.

The motor 304 is configured to receive power from the battery 128 via cables 310 extending between the motor 304 and the battery 128. In the illustrated embodiment, the battery 128 is attached to the motor housing 306, which is mounted on the shaft 116. Accordingly, the motor assembly 302 supports the battery 128 and/or other components of the transducer assembly 300 attached to the battery 128, such as the processor 126. The arrangement of the motor assembly 302 and the battery 128 facilitates the transducer assembly 300 having a compact size and shape and enables the motor 304 to efficiently convert power into rotational movement of the shaft 116.

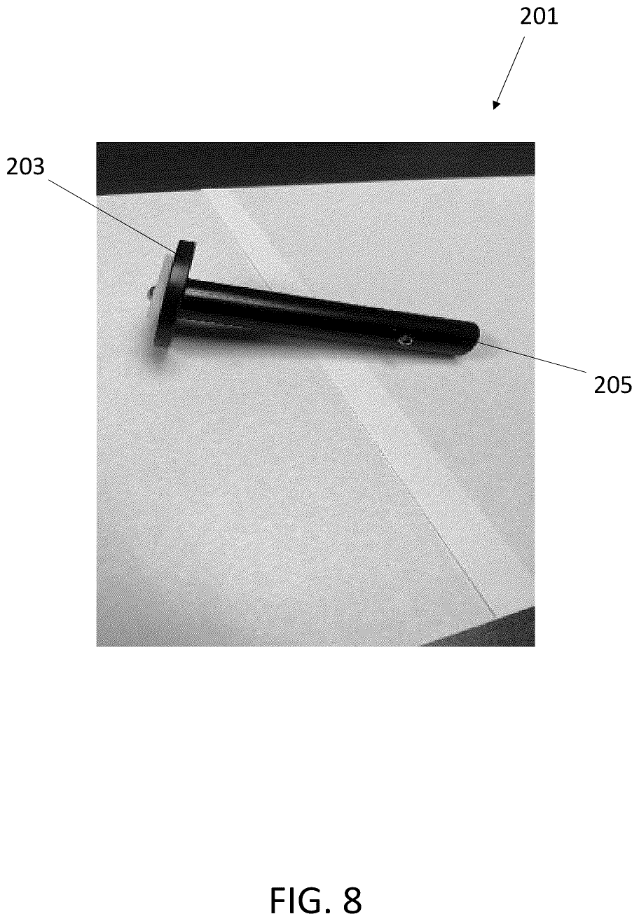

FIG. 8 is a perspective view of a directional member indicated generally at 201 for use with the transducer assembly 200. In some embodiments, the transducer assembly 200 includes the directional member 201 proximate the light assembly 202 and attached to the housing 204 on the shaft 116 at a location above the transducer. The directional member 201 includes an elongate surface 203 at an uppermost end of a body 205 of the directional member 201. The elongate surface 203 is oriented substantially perpendicular to the body 205. The directional member 201 is positioned such that the elongate surface 203 may be rotated 360° as the directional member 201 is rotated with the shaft 116, thereby pointing the elongate surface 203 in the direction faced by the transducer 114 as a visual indication for a user of the field of view of the transducer 114. The light source 206 of the light assembly 202 may be configured to illuminate an area proximate the directional member 201 to allow a user to see a direction of the field of view of the transducer 114 based on the orientation of the elongate surface 203.

Embodiments described above include a fish detection system including a transducer assembly. The transducer assembly may be attached to a trolling motor on a boat and is operable independently of the trolling motor. For example, the transducer assembly is configured to rotate at least 340° independent of rotation of the trolling motor and provides an adjustable field of view. The position of the transducer assembly may be controlled by a wireless remote control such as a foot pedal and/or a handheld control. Accordingly, the transducer assembly reduces the number of cables required on the boat and simplifies installation of the fish detection system. Moreover, the transducer assembly may be compatible with a broader range of systems because the transducer assembly communicates wirelessly and can be programmed for communication with different wireless remote controls.

In addition, embodiments described above include a transducer assembly including a directional member that is configured to move in conjunction with the transducer, the orientation of the directional member corresponding to a direction of the field of view of the transducer, and a light assembly configured to illuminate the directional member. Accordingly, the light assembly indicates which direction the transducer is facing to facilitate accurate controlling of the transducer and enable a person to correlate the information received from the transducer with a physical location.

Also, embodiments described above include a fish detection system with a removable and/or rechargeable battery. The battery enables the fish detection system to be self-powered and not rely on external power sources such as power sources on a boat. As a result, the fish detection system is simpler to install on a broader range of boats. In addition, the battery may be modular, and the fish detection system may accept standardized batteries. Moreover, the battery facilitates a transducer assembly of the fish detection system operating independently of a trolling motor because the transducer assembly does not need to rely on a power source of the trolling motor.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense.

A computing device can be programmed to execute the steps of the method of the present disclosure. A computing device for use with the present disclosure can be loaded with a non-transitory computer readable medium configured to execute activities associated with the present disclosure. The computing device can be incorporated into the sonar system. Alternately, the computing device can be networked to a server or other computing device configured to execute activities associated with the system. The computing device can also be networked to the sonar either using wires or wirelessly in order to obtain the information from the sonar for processing. The information from the sonar can also be input into the computing device manually or using magnetic, optical, or other computer readable media.

As used herein, a non-transitory computer readable medium can be any article of manufacture that contains data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; and paper media, such as punched cards and paper tape. The computer readable medium contains code such that the method described herein can be executed.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fish detection system comprising:
a transducer configured to provide image information for underwater locations, wherein the transducer is configured to rotate to provide an adjustable field of view;
a directional member configured to move in conjunction with the transducer, wherein an orientation of the directional member corresponds to a direction of the adjustable field of view of the transducer; and
a light assembly configured to illuminate the directional member.

2. The fish detection system of claim 1, further comprising a display device that displays location of fish.

3. The fish detection system of claim 2, wherein the display device is communicatively coupled to the transducer.

4. The fish detection system of claim 3, wherein the display device is a digital screen.

5. The fish detection system of claim 4, wherein the display device may be incorporated into a personal computing device.

6. The fish detection system of claim 1, wherein the transducer is configured to rotate at least 340°.

7. The fish detection system of claim 1, wherein the light assembly is attached directly to a motor to be rotated by the motor.

8. The fish detection system of claim 1, wherein any component of the fish detection system may receive power from an external power source.

9. The fish detection system of claim 1, wherein a housing encloses the light assembly and the transducer.

10. The fish detection system of claim 1, wherein the light assembly may be emitted from at least one of a light emitting diode, an incandescent bulb, a laser, a fluorescent light source, and an infrared light source.

11. A fish detection system comprising:
a mount that attaches to a boat that floats on water;
a shaft attached to the mount and configured to extend into the water;
a transducer configured to provide image information for underwater locations;
a rechargeable battery connected to the transducer and configured to supply power to the transducer during operation of the transducer; and
a solar panel for recharging the battery.

12. The fish detection system of claim 11, further comprising a housing, wherein the solar panel is mounted on or forms at least a part of the housing.

13. A fish detection system comprising:
a transducer configured to provide image information for underwater locations;
a motor configured to rotate the transducer to provide an adjustable field of view; and
a wireless remote control device communicatively coupled to the motor and configured to receive user input, wherein the wireless remote control device is configured to selectively actuate the motor and change the adjustable field of view of the transducer.

14. The fish detection system of claim 13, wherein the wireless remote control device comprises a foot pedal.

15. The fish detection system of claim 14, wherein the foot petal is configured to rotate the transducer in at least one of a clockwise direction and a counter-clockwise direction.

16. The fish detection system of claim 13, wherein the wireless remote control device comprises a handheld remote.

17. The fish detection system of claim 13, further comprising a radial position digitizer configured to provide position information of at least one of a shaft, the motor, and the transducer to the wireless remote control device.

18. The fish detection system of claim 13, wherein a depth of the transducer in water may be adjusted by lowering or raising at least one of a shaft and the transducer.

19. The fish detection system of claim 13, wherein the wireless remote control device is incorporated into a personal computing device.

20. The fish detection system of claim 13, wherein the motor is enclosed in a housing.
